(19) United States
(12) Patent Application Publication
(10) Pub. No.: US 2024/0377334 A1
(43) Pub. Date: Nov. 14, 2024

(54) AUTOMATED OPTICAL INSPECTION TOOL

(71) Applicant: Applied Materials, Inc., Santa Clara, CA (US)

(72) Inventors: Mark Anthony Lee, Pflugerville, TX (US); Rodolfo V. Perez, JR., San Bruno, CA (US)

(21) Appl. No.: 18/632,200

(22) Filed: Apr. 10, 2024

Related U.S. Application Data
(60) Provisional application No. 63/465,183, filed on May 9, 2023.

(51) Int. Cl. G01N 21/88; G01N 21/95

(52) U.S. Cl. CPC G01N 21/8806; G01N 21/8851; G01N 21/9501; G01N 2021/8841; G01N 2021/9513; G01N 2201/0638

(57) ABSTRACT

An automated optical inspection tool for inspection of a diffuser includes one or more illumination sources to illuminate an opening structure in the diffuser, and a video microscope unit (VMU) comprising a fixed lens to magnify light reflected from the opening structure. The automated optical inspection tool further includes an optics device comprising a variable focus lens positioned to receive light magnified by the fixed lens, the optics device to focus at different focal depths by varying the variable focus lens, and a camera positioned to receive light as magnified by the fixed lens of the VMU and as focused by the different focal depths of the variable focus lens to capture a series of images of the opening structure in the diffuser.

### RELATED APPLICATIONS

This application claims the benefit of U.S. Provisional Application No. 63/465,183, filed May 9, 2023, the entire contents of which are hereby incorporated by reference herein.

### TECHNICAL FIELD

The instant specification generally relates to electronic device fabrication. More specifically, the instant specification relates to an automated optical inspection tool which can be used to inspect diffusers used for deposition chambers.

### BACKGROUND

An electronic device manufacturing apparatus can include multiple chambers, such as process chambers and load lock chambers. Such an electronic device manufacturing apparatus can employ a robot apparatus in the transfer chamber that is configured to transport substrates between the multiple chambers. In some instances, multiple substrates are transferred together.

Process chambers may be used in an electronic device manufacturing apparatus to perform one or more processes on substrates, such as deposition processes and etch processes. For many processes gases are flowed into the process chamber. Traditionally, the flow of process gases into process chambers is non-uniform. Such non-uniformity in the gas flow can cause some regions of substrates to be exposed to more process gases than other regions of the substrates. As a result, films resulting from the deposition and/or etch processes may be non-uniform.

### SUMMARY

In accordance with an embodiment, an automated optical inspection tool for inspection of a diffuser is provided. The automated optical inspection tool includes one or more illumination sources to illuminate an opening structure in the diffuser, and a video microscope unit (VMU) comprising a fixed lens to magnify light reflected from the opening structure. The automated optical inspection tool further includes an optics device comprising a variable focus lens positioned to receive light magnified by the fixed lens, the optics device to focus at different focal depths by varying the variable focus lens, and a camera positioned to receive light as magnified by the fixed lens of the VMU and as focused by the different focal depths of the variable focus lens to capture a series of images of the opening structure in the diffuser. The opening structure is one of a plurality of opening structures in the diffuser, wherein each of the plurality of opening structures passes through a diffuser body from a front side of the diffuser body to a back side of the diffuser body. The one or more illumination sources includes a front illumination source to illuminate a first end of the opening structure, the first end comprising a conical opening portion in the front side of the diffuser body, and a rear illumination source to illuminate a second end of the opening structure, the second end comprising a cylindrical opening portion in the back side of the diffuser body. The camera comprises a complementary metal-oxide-semiconductor (CMOS) image sensor and the automated optical inspection tool further includes a video microscope unit (VMU) positioned adjacent to the adaptive optics device.

The adaptive optics device includes a cylindrical piezo component surrounding a chamber of liquid, and the cylindrical piezo component vibrates at a frequency to generate a gradient in a refractive index of the liquid, the gradient to focus light passing through the liquid at a focal position based on the frequency. Each image in the series of images is taken at a different focal position corresponding to a different depth through a length of the opening structure in the diffuser. At least a portion of the automated optical inspection tool is mounted on automated motion controlled platform to align the portion of the automated optical inspection tool with each of the plurality of opening structures in the diffuser over a period of time. The automated optical inspection tool further includes a processing system coupled to the camera, the processing system to analyze the series of images to determine whether a defect is present in the opening structure of the diffuser.

In accordance with another embodiment, a diffuser inspection system is provided. The diffuser inspection system includes a diffuser support frame to hold a diffuser in a vertical position, and an automated optical inspection tool for inspection of the diffuser. The automated optical inspection tool includes one or more illumination sources to illuminate an opening structure in the diffuser, and a video microscope unit (VMU) comprising a fixed lens to magnify light reflected from the opening structure. The automated optical inspection tool further includes an optics device comprising a variable focus lens positioned to receive light magnified by the fixed lens, the optics device to focus at different focal depths by varying the variable focus lens, and a camera positioned to receive light as magnified by the fixed lens of the VMU and as focused by the different focal depths of the variable focus lens to capture a series of images of the opening structure in the diffuser. The opening structure is one of a plurality of opening structures in the diffuser, wherein each of the plurality of opening structures passes through a diffuser body from a front side of the diffuser body to a back side of the diffuser body. The one or more illumination sources includes a front illumination source to illuminate a first end of the opening structure, the first end comprising a conical opening portion in the front side of the diffuser body, and a rear illumination source to illuminate a second end of the opening structure, the second end comprising a cylindrical opening portion in the back side of the diffuser body. The camera comprises a complementary metal-oxide-semiconductor (CMOS) image sensor and the automated optical inspection tool further includes a video microscope unit (VMU) positioned adjacent to the adaptive optics device.

The adaptive optics device includes a cylindrical piezo component surrounding a chamber of liquid, and the cylindrical piezo component vibrates at a frequency to generate a gradient in a refractive index of the liquid, the gradient to focus light passing through the liquid at a focal position based on the frequency. Each image in the series of images is taken at a different focal position corresponding to a different depth through a length of the opening structure in the diffuser. At least a portion of the automated optical inspection tool is mounted on automated motion controlled platform to align the portion of the automated optical inspection tool with each of the plurality of opening structures in the diffuser over a period of time. The diffuser inspection system further includes a processing system coupled to the camera, the processing system to analyze the series of images to determine whether a defect is present in the opening structure of the diffuser.

In accordance with yet another embodiment, a method is provided. The method includes aligning an automated optical inspection tool with each of a plurality of opening structures in a diffuser over a period of time, and capturing a respective series of images of each of the plurality of opening structures in the diffuser. The method further includes analyzing each respective series of images to determine whether a defect is present in each corresponding opening structure in the diffuser. The automated optical inspection tool includes one or more illumination sources to illuminate each opening structure in the diffuser, and a video microscope unit (VMU) comprising a fixed lens to magnify light reflected from the opening structure. The automated optical inspection tool further includes an optics device comprising a variable focus lens positioned to receive light magnified by the fixed lens, the optics device to focus at different focal depths by varying the variable focus lens, and a camera positioned to receive light as magnified by the fixed lens of the VMU and as focused by the different focal depths of the variable focus lens to capture a series of images of the opening structure in the diffuser.

### BRIEF DESCRIPTION OF THE DRAWINGS

Aspects and implementations of the present disclosure will be understood more fully from the detailed description given below and from the accompanying drawings, which are intended to illustrate aspects and implementations by way of example and not limitation.

FIG. 1 is a perspective view of a diffuser inspection system including an automated optical inspection tool, in accordance with some embodiments.

FIG. 2 is a cross-sectional view of a portion of an example diffuser, in accordance with some embodiments.

FIG. 3 is a block diagram illustrating an automated optical inspection tool, in accordance with some embodiments.

FIG. 4A illustrates an adaptive optics device with a variable focus lens for use in an automated optical inspection tool, in accordance with some embodiments.

FIG. 4B illustrates operation of an adaptive optics device with a variable focus lens in an automated optical inspection tool, in accordance with some embodiments.

FIG. 5 illustrates a series of images captured by an automated optical inspection tool, in accordance with some embodiments.

FIG. 6 is a flow chart of an example method for diffuser inspection using an automated optical inspection tool, in accordance with some embodiments.

FIG. 7 is a block diagram illustrating an exemplary processing system, in accordance with some embodiments.

### DETAILED DESCRIPTION

Processes for fabrication of electronic devices (e.g., display devices) generally include deposition of material (e.g., one or more thin film layers) on a substrate or wafer, and processing of the material. Deposition chamber systems, such as chemical vapor deposition (CVD) chamber systems, utilize process gases to perform a deposition process to deposit the material onto a substrate. Examples of CVD deposition processes include plasma enhanced (PE) CVD, thermally enhanced (TE) CVD, high density plasma (HDP) CVD, etc. To perform such CVD deposition processes, a substrate or wafer can be placed within a reactor chamber, and chemical vapors can be introduced into the reactor chamber that cause deposition of a particular material. For example, the particular material can be a dielectric material. One example of a dielectric material that can be deposited using a deposition process is a silicon oxide (SiOₓ). For example, the material can include a dielectric stack including pairs of alternating oxide and nitride layers, where each pair of layers is formed during a particular PECVD cycle. In some embodiments, the oxide layer can include a silicon oxide material (e.g., SiO₂) and the nitride layer can include a silicon nitride material (e.g., SiN).

Liquid crystal displays or flat panels are commonly used for active matrix displays such as computer monitors and television monitors. PECVD is generally employed to deposit thin films on a substrate, such as a transparent substrate for flat panel display or semiconductor wafer. PECVD is generally accomplished by introducing a precursor gas or gas mixture into a vacuum chamber that contains a substrate disposed on a temperature-controlled substrate support (e.g., susceptor). The gas mixture can include reactant gases that combine to form material on the substrate, and inert gases. The precursor gas or gas mixture is typically directed through a distribution plate situated near the top or side of the chamber. The gas mixture can be energized or excited into a plasma by applying radio frequency (RF) power to the chamber from one or more RF sources coupled to the chamber, where the excited inert gases can cause sputter etching of the material being formed on the substrate by the reactant gases. Thus, the combination of deposition and etching can be used to fill portions of a device (e.g., a display device) with dielectric material. The deposition rate is directly related to the reactant gas flow rate, and the etch rate is directly related to the inert gas flow rate. However, the ratio between the deposition rate and the etch rate should be controlled to enable controlled dielectric material deposition and removal. This is particularly true as device features become smaller and have higher aspect ratios. To control the reactant gas flow rate and/or the inert gas flow rate, and thus the ratio between the deposition rate and the etch rate, a CVD deposition chamber can utilize a gas delivery system including a gas distribution plate or diffuser that functions to control the distribution of the reactant gases and/or inert gases, and gas lines that direct the reactant gases and/or inert gases into the reactor.

Flat panels for display devices processed by PECVD techniques can be large in area, often exceeding 3 square meters. Diffusers utilized to provide uniform process gas flow over flat panels are relatively large in size, particularly as compared to diffusers utilized for semiconductor device wafer processing. Such diffusers include a number of opening structures that extend through the diffuser body allowing gas flow from one side (i.e., a source) to another (i.e., the side facing the substrate). The spacing and arrangement of these opening structures are designed to provide uniform gas flow. Any imperfection in the size, shape, orientation, placement, etc. of the opening structures can lead to variations in the gas flow through the diffuser. These variations can adversely affect processing parameters such as film thickness, deposition uniformity and/or film stress. Accordingly, the opening structures may be inspected at various times. As the size of these diffusers increases to match the size of the substrates used to form larger display devices, the number of opening structures in the diffusers also increases (e.g., into the tens or hundreds of thousands). This can add substantial strain to the inspection process, which is often performed manually (e.g., using pin gauges to measure a sample of the opening structures and extrapolating the results for the entire diffuser). Such an inspection is operator dependent and subject to variability based on operator experience and capability, and is further limited to only a small portion (e.g., less than 1%) of the opening structures in the diffuser. As a result, problems in the diffusers can often be overlooked, resulting in less than ideal processing conditions.

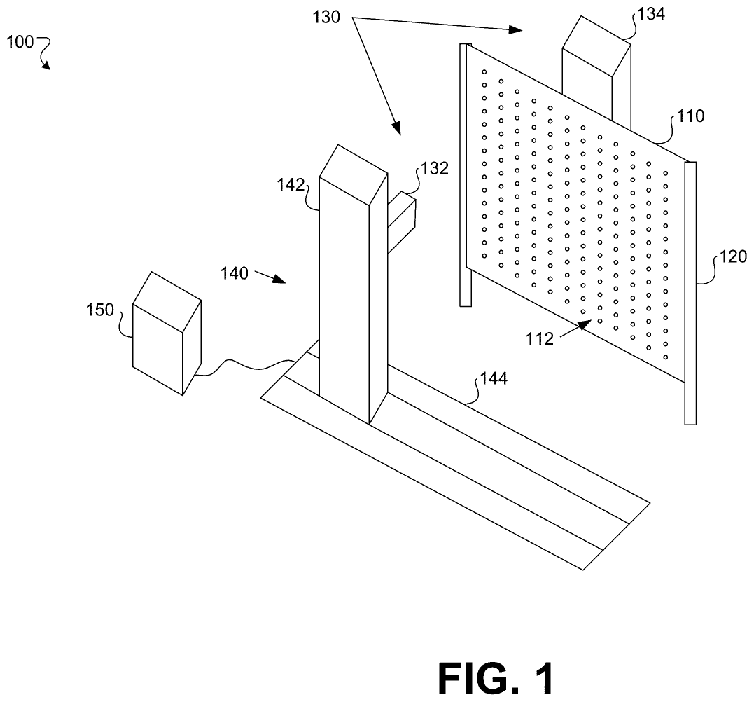

Aspects and implementations of the present disclosure address these and other shortcomings of existing technologies by providing an automated optical inspection tool for deposition chamber system diffusers (“diffusers”). The automated optical inspection tool provides quantitative measurement of key dimensional features of the diffusers that can replace manual inspection processes with state-of-the art optical inspection capability. The automated optical inspection tool can provide a comprehensive and detailed output of key attributes of the individual opening structures in the diffuser such as diffusion hole diameter and length which are relevant to the performance of the diffuser. This metrology tool provides the ability to perform 100% inspection of the various features of each opening structure using front and back illumination sources, a camera (e.g., a CMOS camera) and a series of lenses, including for example, an adaptive optics device with a variable focus lens. In one embodiment, the automated optical inspection tool can be mounted on an automated motion controlled platform that can align the tool with each opening structure in the diffuser to allow for measurements to be completed. Data representing the measurements can be provided to a processing device or other computing system for further analysis and identification of defects in the opening structures of the diffuser. The automated optical inspection tool can allow for full inspection of even the largest diffusers within hours which can identify defects or variations impacting quality and performance of the diffusers. Additional details regarding the automated optical inspection tool are provided below with respect to FIGS. 1-6.

FIG. 1 is a perspective view of a diffuser inspection system including an automated optical inspection tool, in accordance with some embodiments. As shown, the system 100 includes a gas distribution plate or diffuser 110 which can be held in a frame 120 or other support structure. As described herein, the system 100 further includes an automated optical inspection tool 130 to inspect to perform a comprehensive, accurate, and efficient inspection of the diffuser 110.

The diffuser 110 described herein can be designed for implementation within any suitable deposition chamber system. In some embodiments, the diffuser 110 is designed to be implemented within a plasma enhanced chemical vapor deposition system (PECVD) configured to process large area substrates (e.g., for fabrication of thin film, flat panel displays).

As illustrated, the diffuser 110 can include a number of opening structures 112 formed within the diffuser block. More specifically, the opening structures 112 be formed (e.g., drilled) through a front-side surface to a back-side surface. Forming the opening structures 112 can include forming substantially similar sized conical openings through the front-side surface, and forming substantially similar sized cylindrical openings through the back-side surface. Therefore, the opening structures have first ends corresponding to the circular base ends of the conical openings, and second ends corresponding to the circular ends of the backside cylindrical openings, where the second ends each have a substantially same diameter. The opening structures 112 collectively provide the diffuser 110 with a design for controlling gas flow and enabling uniform gas flow distribution. The diffuser 110 can have a number of rows of opening structures 112 where, in one embodiment, each opening structure 112 of the row is approximately evenly spaced apart and the rows themselves are evenly spaced apart. Depending on the implementation, the number, spacing, and distribution of the opening structures 112 can vary according to the specific requirements of the deposition system and of the substrates to be processed.

In one embodiment, the frame 120 holds the diffuser 110 in a vertical position such that the conical opening structures 110 are exposed and visible to the automated optical inspection tool 130. The automated optical inspection tool 130 will be described in more detail below, however, in at least one embodiment, the automated optical inspection tool 130 includes a first portion 132 positioned on the front side of the diffuser 110 and a second portion 134 positioned on the back side of the diffuser 110. In one embodiment, at least the first portion 132 of the automated optical inspection tool 130 is mounted on an automated motion controlled platform 140 that can align the first portion 132 with each opening structure 112 in the diffuser 110 to allow for measurements to be completed. For example, the automated motion controlled platform 140 can include a tower 142 that moves horizontally along one or more tracks in a base 144. In addition, the first portion 132 of the automated optical inspection tool 130 can move vertically up and down the tower 142 in order to align with different opening structures 112 in the diffuser 110. In one embodiment, the motion controlled platform 140, and thus the positioning of the automated optical inspection tool 130, is controlled by processing system 150. In addition, data representing the measurements taken by the automated optical inspection tool 130 can be provided to processing system 150 for further analysis and identification of defects in the opening structures 112 of the diffuser 110. In different embodiments, the processing system 150 can be in the form of a computer system within which a set of instructions, for causing the machine to perform any one or more of the methodologies discussed herein, may be executed. For example, the processing system 150 may be a personal computer (PC), a set-top box (STB), a server, a network router, switch or bridge, or any machine capable of executing a set of instructions (sequential or otherwise) that specify actions to be taken by that system. Further, while only a single processing system is illustrated, the term “processing system” shall also be taken to include any collection of machines that individually or jointly execute a set (or multiple sets) of instructions to perform any one or more of the methodologies discussed herein.

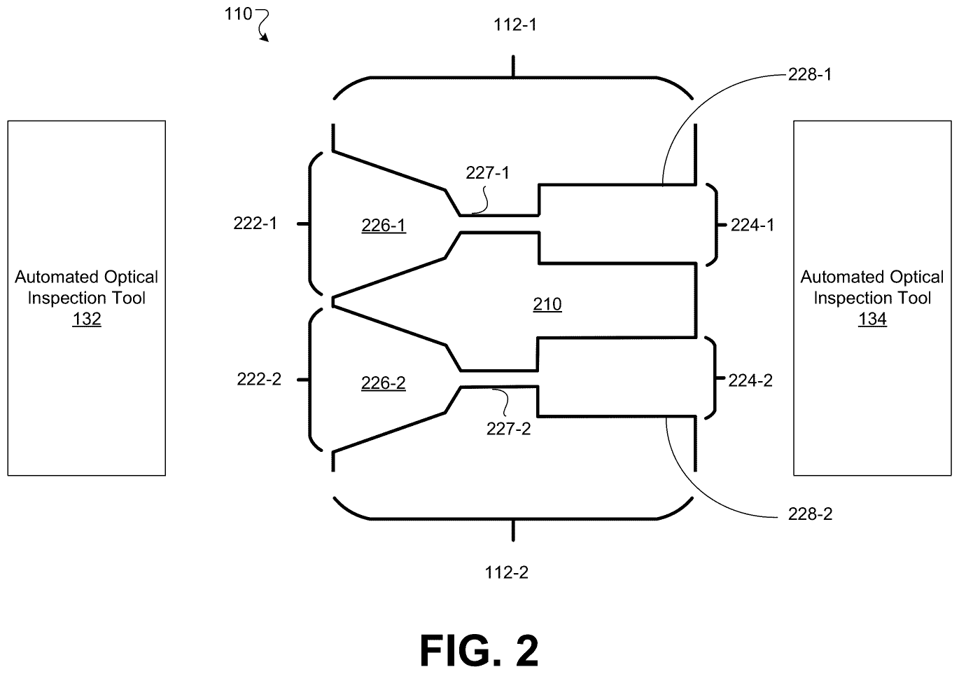

FIG. 2 is a cross-sectional view of a portion of an example diffuser 110, in accordance with some embodiments. As shown, the diffuser 110 includes a diffuser block 210. The diffuser block 210 can be formed from any suitable material in accordance with embodiments described herein. For example, the diffuser block 210 can include aluminum (Al). The diffuser block 210 includes a number of opening structures 112-1 and 112-2 formed through the diffuser block 210. The opening structures 112-1 and 112-2 can have a substantially same geometry. Although two opening structures are shown in FIG. 2, the diffuser 110 can have any suitable number of opening structures.

The opening structure 112-1 includes a first end 222-1 and a second end 224-1, and the opening structure 112-2 includes a first end 222-2 and a second end 224-2. Moreover, the opening structure 112-1 includes a conical opening portion 226-1 and a cylindrical opening portion 228-1, and the opening structure 112-2 includes a conical opening portion 226-2 and a cylindrical opening portion 228-2. That is, the first ends 222-1 and 222-2 of the opening structures 112-1 and 112-2 correspond to circular base ends of the conical opening portions 226-1 and 226-2, respectively, and the second ends 224-1 and 224-2 of the opening structures 112-1 and 112-2 correspond to ends of the cylindrical opening portions 228-1 and 228-2, respectively. In one embodiment, each of conical opening portions 226-1 and 226-2 are connected to the respective cylindrical opening portions 228-1 and 228-2 by a narrower diffusion hole. For example, conical opening portion 226-1 is connected to cylindrical opening portion 228-1 via diffusion hole 227-1 and conical opening portion 226-2 is connected to cylindrical opening portion 228-2 via diffusion hole 227-2. In one embodiment, the diffusion holes 227-1 and 227-2 each have a narrower diameter than either conical opening portions 226-1 and 226-2 or cylindrical opening portions 228-1 and 228-2.

In one embodiment, the automated optical inspection tool 130 is positioned relative to the diffuser 110 such that the first portion 132 is adjacent to the front side of the diffuser 110 (i.e., the side including conical opening portions 226-1 and 226-2) and the second portion 134 is adjacent to the back side of the diffuser 110 (i.e., the side including cylindrical opening portions 228-1 and 228-2). In one embodiment, as described in more detail below, the first portion 132 of the automated optical inspection tool 130 includes a front illumination source, a camera, and a series of lenses, including for example, a video microscope unit (VMU), and an adaptive optics device with a variable focus lens. In one embodiment, the second portion 134 of the automated optical inspection tool 130 includes a back illumination source.

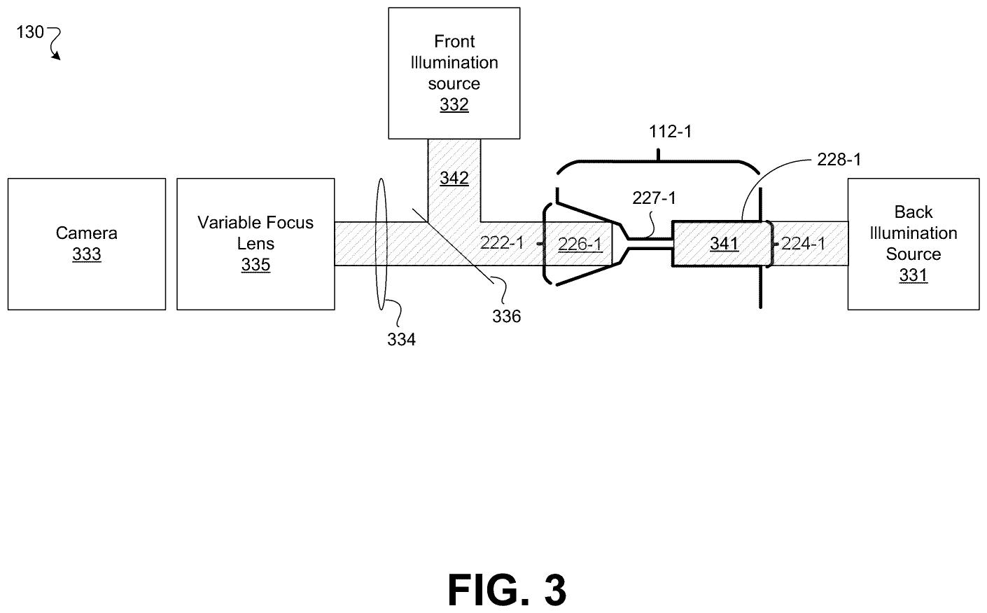

FIG. 3 is a block diagram illustrating an automated optical inspection tool 130, in accordance with some embodiments. As illustrated the automated optical inspection tool 130 includes a back illumination source 331, a front illumination source 332, a camera 333, and a series of lenses, including for example, a video microscope unit (VMU) 334 and an adaptive optics device with a variable focus lens 335. These components of automated optical inspection tool 130 are shown in position to inspect opening structure 112-1.

Back illumination source 331 and front illumination source 332 can include any suitable illumination sources, such as for example, light emitting diode (LED) lights, halogen lights, fluorescent lights, fiber optic lights, ultraviolet lights, infrared lights, or other lights. In one embodiment, back illumination source 331 is positioned so as to cast light 341 through the second end 224-1 of the opening structure 112-1 and into cylindrical opening portion 228-1. In certain embodiments, at least a portion of the light 341 may pass through diffusion hole 227-1. In one embodiment, front illumination source 332 is positioned so as to cast light 342 through a beamsplitter 336. The beamsplitter 336 can reflect the light 342 from the front illumination source 332 towards the first end 222-1 of the opening structure 112-1 and into conical opening portion 226-1. In certain embodiments, at least a portion of the light 342 may pass through diffusion hole 227-1. In addition, at least a portion of the light 342 is reflected from opening structure 112-1 and passes through beamsplitter 336 to a video microscope unit (VMU) 334 and adaptive optics device 335, and eventually to camera 333.

The video microscope unit (VMU) 334 can include an optical system, including one or more objective lenses, depending on the embodiment. The objective lens in the VMU 334 gathers and magnifies the light 342 reflected back from opening structure 112-1, which in connection with adaptive optics device 335, allows the camera 333 to focus at different depths within diffusion hole 227-1. The objective lens can include a compound lens (i.e., multiple lens elements), for example, and has a high numerical aperture, thus permitting a high degree of resolution. The objective lens of VMU 334 focuses the light 342 reflected back from opening structure 112-1 through the variable focus lens of adaptive optics device 335, and eventually to camera 333. Thus, the automated optical inspection tool 130 uses a combination of the variable focus lens of adaptive optics device 335 and a fixed lens (i.e., the objective lens) of VMU 334 to accurately capture images of each diffusion hole 227-1.

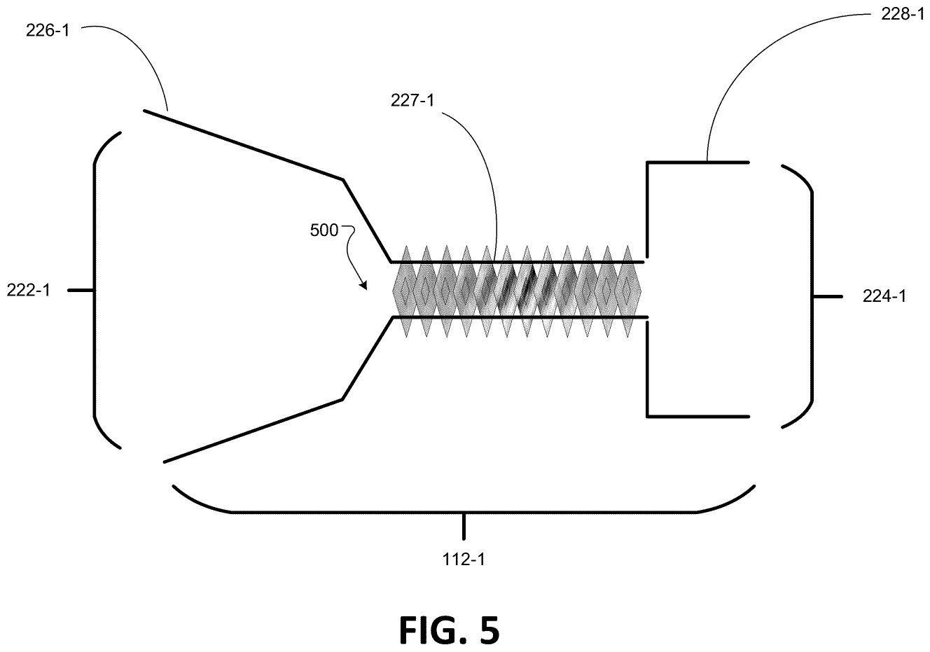

Camera 333 can be any suitable type of camera or image sensor, such as for example, a charge-coupled device (CCD) sensor, complementary metal-oxide-semiconductor (CMOS) sensor, or other image sensor. In one embodiment, camera 333 can capture a series of images (e.g., an image stack) of the internal portions of diffusion hole 227-1, such as where each image corresponds a different depth through the length of the diffusion hole 227-1, as illustrated in FIG. 5. In one embodiment, data representing the measurements taken by the automated optical inspection tool 130 (i.e., the series of images captured by camera 333) can be provided to processing system 150 for further analysis and identification of defects in the diffusion hole 227-1. In addition, as the automated motion control system 140 aligns the automated optical inspection tool 130 with each opening structure 112 in the diffuser 110, the camera 333 can similarly capture a corresponding series of images of the diffusion hole in each opening structure 112, which can all be provided to processing system for analysis and defect identification.

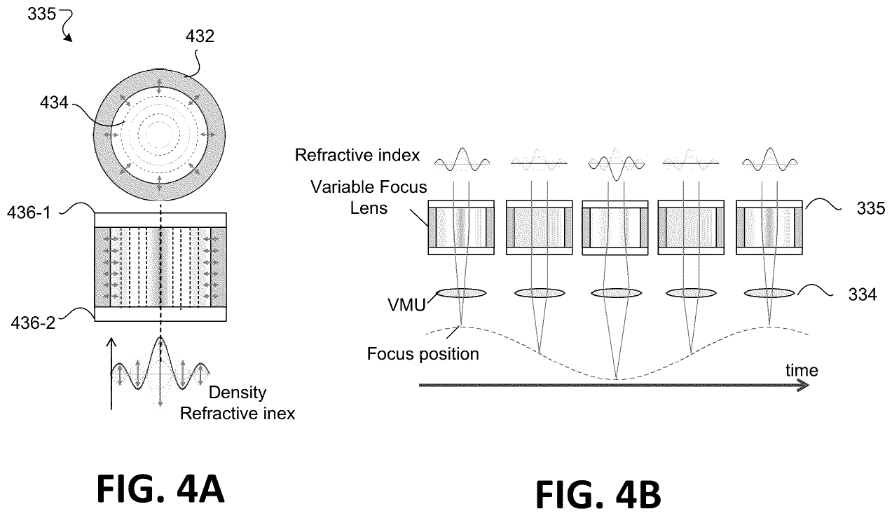

In one embodiment, video microscope unit (VMU) 334 and adaptive optics device 335 allow camera 333 to focus at different focal depths in order to capture the series of images of the opening structure 112-1. As described in more detail below with respect to FIG. 4A and FIG. 4B, adaptive optics device 335 is a type of lens that uses vibration to change its shape and focus light. The adaptive optics device 335 includes a thin layer of fluid, usually water or oil, sandwiched between two layers of glass. When an acoustic wave is applied to the fluid layer, it creates a gradient in the fluid's refractive index, which causes the light passing through it to bend and focus. The acoustic wave can be controlled by adjusting its frequency and amplitude, which changes the shape of the fluid layer and the focus of the adaptive optics device 335. This allows the adaptive optics device 335 to be tuned to different focal lengths and to focus on objects at different distances. It is also able to change focus quickly, which makes it useful for scanning objects at different depths in short periods of time.

FIG. 4A illustrates a tunable acoustic gradient index of refraction lens for use in an automated optical inspection tool, in accordance with some embodiments. In one embodiment, the adaptive optics device 335 is cylindrical in shape with a cylindrical piezo component 432 surrounding a chamber of liquid 434. In one embodiment, two glass plates 436-1 and 436-2 are positioned on the top and bottom of the cylinder, thus holding the liquid 434 within in the piezo component 432. The liquid 434 can be water or oil, or any other fluid with a relatively low acoustic attenuation coefficient and a relatively high refractive index.

When the piezo component 432 is activated (e.g., to generate an acoustic wave that is applied to the liquid 434), it creates a pressure gradient that causes the liquid 434 to compress and expand. This compression and expansion create a gradient in the refractive index of the liquid 434. The highest index is at the point of maximum compression, and the lowest index is at the point of maximum expansion, as shown in FIG. 4B. The gradient in the refractive index of the liquid 434 causes light passing through the liquid 434 to bend, which focuses the light, similar to a traditional lens. However, unlike traditional lenses, the adaptive optics device 335 can change its shape and focus by controlling the frequency and amplitude of the acoustic wave, such as by controlling the vibration of the piezo component 432. In one embodiment, the piezo component 432 vibrates at the resonant frequency of the liquid 343 and a standing wave is formed in the liquid 434 leading to modulation of mass density. The refractive index of the liquid 434 is proportional to its density and follows the distribution/modulation of the mass density. This allows the focal length of the adaptive optics device 335 to be tuned to different values, making it highly versatile. For example, when used in combination with a video microscope unit (VMU) 334, the adaptive optics device 335 can change the focus position over time, such as to capture the series of images at different depths through the length of opening structure 112-1.

FIG. 5 illustrates a series of images captured by an automated optical inspection tool, in accordance with some embodiments. As described above, camera 333 can capture a series of images 500 (e.g., an image stack) of the internal portions of the diffusion hole 227-1, such as where each image corresponds a different depth through the length of the diffusion hole 227-1. For example, a first image in the image stack may be closest to the first end 222-1 of the opening structure 112-1, a number of successive images in the image stack may correspond to the diffusion hole 227-1, while a final image in the image stack may be closest to the second end 224-1 of the opening structure 112-1. As describe above, adaptive optics device 335 and VMU 334 can be used to focus camera 330 at different focal depths in order to capture each of the images in the series 500. Those focal depths (i.e., the distance between where each image in series 500 is capture) can be uniform (i.e., equally spaced) or varied (i.e., with different spacings). The number of images in the series 500, as well as the spacings between, can vary depending on the specific implementation. In other embodiments, the order of the images in the image stack 500 can be reversed, such that the first image is closest to the second end 224-1 of the opening structure 112-1 and the final image is closest to the first end 222-1 of the opening structure 112-1.

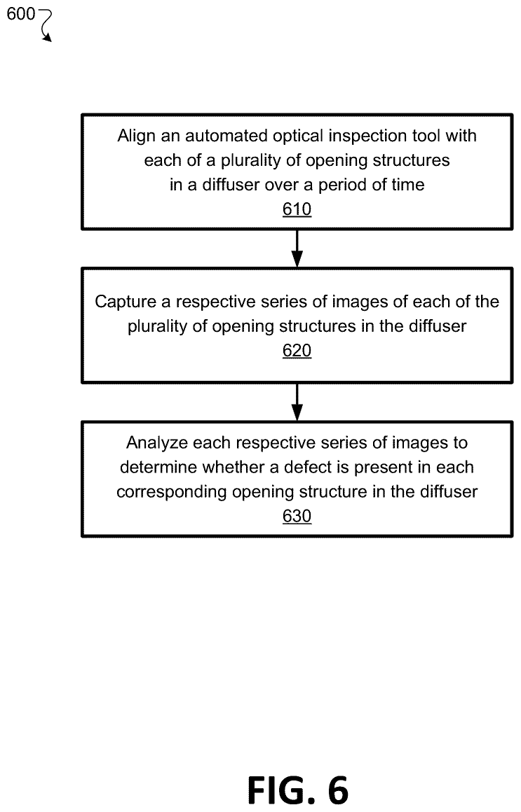

FIG. 6 is a flow chart of an example method for diffuser inspection using an automated optical inspection tool, in accordance with some embodiments. The method 600 may be performed by processing logic that comprises hardware (e.g., circuitry, dedicated logic, programmable logic, microcode, etc.), software (e.g., instructions run on a processor to perform hardware simulation), firmware, or a combination thereof. The processing logic is configured to provide a comprehensive and detailed output of key attributes of the individual opening structures in the diffuser such as diffusion hole diameter and length which are relevant to the performance of the diffuser. In one embodiment, method 600 may be performed by diffuser inspection system 100 including automated optical inspection tool 130, as shown in FIG. 1.

At operation 610, the processing logic aligns an automated optical inspection tool 130 with each of a plurality of opening structures 112 in a diffuser 110 over a period of time. In one embodiment, the automated optical inspection tool 130 includes one or more illumination sources 331 and 332 to illuminate each opening structure 112 in the diffuser 110, a camera 333, and an adaptive optics device 335 positioned adjacent to the camera 333. In one embodiment, at least a portion of the automated optical inspection tool 130 is mounted on automated motion controlled platform 140 to align the portion of the automated optical inspection tool 130 with each of the plurality of opening structures 112 in the diffuser 110. For example, the automated motion controlled platform 140 can include a tower 142 that moves horizontally along one or more tracks in a base 144. In addition, the portion of the automated optical inspection tool 130 can move vertically up and down the tower 142 in order to align with different opening structures 112 in the diffuser 110. In one embodiment, the motion controlled platform 140, and thus the positioning of the automated optical inspection tool 130, is controlled by processing system 150.

At operation 620, the processing logic captures a respective series of images 500 of each of the plurality of opening structures 112 in the diffuser 110. In one embodiment, the adaptive optics device 335 serves to focus the camera 333 at different focal depths in order to capture the series of images 500 of each opening structure 112. For example, the adaptive optics device 335 includes a cylindrical piezo component 432 surrounding a chamber of liquid 434, and the cylindrical piezo component 432 vibrates at a frequency to generate a gradient in a refractive index of the liquid 434, the gradient to focus light passing through the liquid 434 at a focal position based on the frequency. Each image in the series of images 500 is taken at a different focal position corresponding to a different depth through a length of the diffusion hole 227 (and optionally the conical opening 226) in each opening structure 112 in the diffuser 110.

At operation 630, the processing logic analyzes each respective series of images to determine whether a defect is present in each corresponding opening structure in the diffuser. A defect can be in the form of physical obstruction (i.e. burr, or contamination) inside the diffusion hole that will affect the diameter or deviations in the dimensional tolerance of the opening structures. In one embodiment, processing system 150 receives each series of images 500 and performs an analysis to determine whether a defect is present in the corresponding opening structure 112 of the diffuser 110. In one embodiment, processing system 150 collects data and images and compares them to specified dimensions and tolerances to determine if they meet established requirements. Depending on the embodiment, the following opening structure attributes in the diffuser can be confirmed: cone-side opening diameter and depth 226-1, diffusion hole diameter and length 227-1. The processing logic will identify of each of the opening structures that are dimensionally non-compliant and will keep records for additional review and analysis. The processing logic can provide total count and location of non-compliant openings to determine final acceptance.

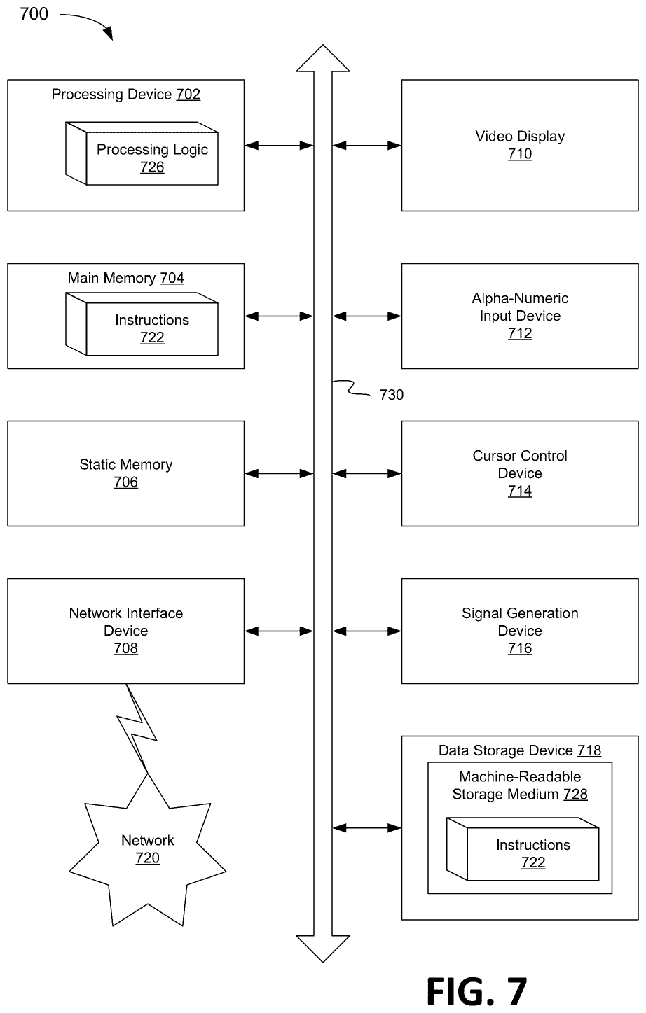

FIG. 7 illustrates a diagrammatic representation of a machine in the exemplary form of a processing system 700 within which a set of instructions, for causing the machine to perform any one or more of the methodologies discussed herein, may be executed. The system 700 may be in the form of a computer system within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, processing system 700 may be representative of processing system 150, as shown in FIG. 1.

The exemplary processing system 700 includes a processing device (processor) 702, a main memory 704 (e.g., read-only memory (ROM), flash memory, dynamic random access memory (DRAM) such as synchronous DRAM (SDRAM)), a static memory 706 (e.g., flash memory, static random access memory (SRAM)), and a data storage device 718, which communicate with each other via a bus 730.

Processing device 702 represents one or more general-purpose processing devices such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also be one or more special-purpose processing devices such as an application specific integrated circuit (ASIC), a field programmable gate array (FPGA), a digital signal processor (DSP), network processor, or the like.

The processing system 700 may further include a network interface device 708. The processing system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker).

The data storage device 718 may include a computer-readable medium 728 on which is stored one or more sets of instructions 722 (e.g., the instructions of personal safety service client and server applications) embodying any one or more of the methodologies or functions described herein. The instructions 722 may also reside, completely or at least partially, within the main memory 704 and/or within processing logic 726 of the processing device 702 during execution thereof by the processing system 700, the main memory 704 and the processing device 702 also constituting computer-readable media. The instructions may further be transmitted or received over a network 720 via the network interface device 708.

While the processing-readable storage medium 728 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

The preceding description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ±10%.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A diffuser inspection system comprising:
a diffuser support frame to hold a diffuser in a vertical position; and
an optical inspection tool for inspection of the diffuser, the optical inspection tool comprising:
one or more illumination sources to illuminate an opening structure in the diffuser;
a video microscope unit (VMU) comprising a fixed lens to magnify light reflected from the opening structure;
an optics device comprising a variable focus lens positioned to receive light magnified by the fixed lens, the optics device to focus at different focal depths by varying the variable focus lens; and
a camera positioned to receive light as magnified by the fixed lens of the VMU and as focused by the different focal depths of the variable focus lens to capture a series of images of the opening structure in the diffuser.

2. The diffuser inspection system of claim 1, wherein the opening structure is one of a plurality of opening structures in the diffuser, wherein each of the plurality of opening structures passes through a diffuser body from a front side of the diffuser body to a back side of the diffuser body.

3. The diffuser inspection system of claim 2, wherein the one or more illumination sources comprise:
a front illumination source to illuminate a first end of the opening structure, the first end comprising a conical opening portion in the front side of the diffuser body; and
a rear illumination source to illuminate a second end of the opening structure, the second end comprising a cylindrical opening portion in the back side of the diffuser body.

4. The diffuser inspection system of claim 1, wherein the camera comprises a complementary metal-oxide-semiconductor (CMOS) image sensor.

5. The diffuser inspection system of claim 1, wherein the optics device comprises a cylindrical piezo component surrounding a chamber of liquid.

6. The diffuser inspection system of claim 5, wherein the cylindrical piezo component vibrates at a frequency to generate a gradient in a refractive index of the liquid, the gradient to focus light passing through the liquid at a focal position based on the frequency.

7. The diffuser inspection system of claim 6, wherein each image in the series of images is taken at a different focal position corresponding to a different depth through a length of a diffusion hole in the opening structure in the diffuser.

8. The diffuser inspection system of claim 2, wherein at least a portion of the optical inspection tool is mounted on a motion controlled platform to align the portion of the optical inspection tool with each of the plurality of opening structures in the diffuser over a period of time.

9. The diffuser inspection system of claim 1, further comprising:
a processing system coupled to the camera, the processing system to analyze the series of images to determine whether a defect is present in the opening structure of the diffuser.

10. An optical inspection tool for inspection of a diffuser comprising:
one or more illumination sources to illuminate an opening structure in the diffuser;
a video microscope unit (VMU) comprising a fixed lens to magnify light reflected from the opening structure;
an optics device comprising a variable focus lens positioned to receive light magnified by the fixed lens, the optics device to focus at different focal depths by varying the variable focus lens; and
a camera positioned to receive light as magnified by the fixed lens of the VMU and as focused by the different focal depths of the variable focus lens to capture a series of images of the opening structure in the diffuser.

11. The optical inspection tool of claim 10, wherein the opening structure is one of a plurality of opening structures in the diffuser, wherein each of the plurality of opening structures passes through a diffuser body from a front side of the diffuser body to a back side of the diffuser body.

12. The optical inspection tool of claim 11, wherein the one or more illumination sources comprise:
a front illumination source to illuminate a first end of the opening structure, the first end comprising a conical opening portion in the front side of the diffuser body; and
a rear illumination source to illuminate a second end of the opening structure, the second end comprising a cylindrical opening portion in the back side of the diffuser body.

13. The optical inspection tool of claim 10, wherein the camera comprises a complementary metal-oxide-semiconductor (CMOS) image sensor.

14. The optical inspection tool of claim 10, wherein the optics device comprises a cylindrical piezo component surrounding a chamber of liquid.

15. The optical inspection tool of claim 14, wherein the cylindrical piezo component vibrates at a frequency to generate a gradient in a refractive index of the liquid, the gradient to focus light passing through the liquid at a focal position based on the frequency.

16. The optical inspection tool of claim 15, wherein each image in the series of images is taken at a different focal position corresponding to a different depth through a length of a diffusion hole in the opening structure in the diffuser.

17. The optical inspection tool of claim 11, wherein at least a portion of the optical inspection tool is mounted on automated motion controlled platform to align the portion of the optical inspection tool with each of the plurality of opening structures in the diffuser over a period of time.

18. The optical inspection tool of claim 10, further comprising:
a processing system coupled to the camera, the processing system to analyze the series of images to determine whether a defect is present in the opening structure of the diffuser.

19. A method comprising:
aligning an optical inspection tool with each of a plurality of opening structures in a diffuser over a period of time;
capturing a respective series of images of each of the plurality of opening structures in the diffuser; and
analyzing each respective series of images to determine whether a defect is present in each corresponding opening structure in the diffuser.

20. The method of claim 19, wherein the optical inspection tool comprises:
one or more illumination sources to illuminate each opening structure in the diffuser;
a video microscope unit (VMU) comprising a fixed lens to magnify light reflected from the opening structure;
an optics device comprising a variable focus lens positioned to receive light magnified by the fixed lens, the optics device to focus at different focal depths by varying the variable focus lens; and
a camera positioned to receive light as magnified by the fixed lens of the VMU and as focused by the different focal depths of the variable focus lens to capture a series of images of the opening structure in the diffuser.
